(19) United States
(12) Patent Application Publication
(10) Pub. No.: US 2024/0249876 A1
(43) Pub. Date: Jul. 25, 2024

(54) COIL DEVICE

(71) Applicant: TDK Corporation, Tokyo (JP)

(72) Inventors: Toshiyuki HORIKAWA, Tokyo (JP); Kiho Hwang, Tokyo (JP)

(73) Assignee: TDK Corporation, Tokyo (JP)

(21) Appl. No.: 18/419,011

(22) Filed: Jan. 22, 2024

(30) Foreign Application Priority Data
Jan. 23, 2023 (JP) 2023-008328

(51) Int. Cl. H01F 27/32; H01F 27/24; H01F 27/30

(52) U.S. Cl. CPC H01F 27/325; H01F 27/24; H01F 27/306

(57) ABSTRACT

A coil device includes a first coil and a second coil, bobbins combined with each other and provided with the first coil and the second coil, and a core attached to the bobbins. The core includes a pair of outer leg portions, a middle leg portion located between the pair of outer leg portions, and a protrusion located between one of the outer leg portions and the middle leg portion. The second coil is disposed in a range different from that of the first coil so as to surround the middle leg portion and the protrusion.

### BACKGROUND OF THE INVENTION

The present invention relates to a coil device.

Patent Document 1 discloses the following two types of coil devices as coil devices used as leakage transformers. The first coil device includes a first coil and a second coil disposed outside the first coil in its radial direction. The second coil device includes a first coil and a second coil disposed on one side of the first coil in its winding axis direction.

In both of the first coil device and the second coil device, for the purpose of adjusting the coupling degree between the first coil and the second coil, it is necessary to adjust the distance between the first coil and the second coil. That is, it is necessary to adjust the distance between the first coil and the second coil in their radial directions in the first coil device, and it is necessary to adjust the distance between the first coil and the second coil in their winding axis directions in the second coil device.

However, it is not easy to adjust the distance between the first coil and the second coil so as to obtain a desired coupling degree. Also, the first coil device may become larger along the radial direction of the first coil or the second coil, and the second coil device may become larger along the winding axis direction of the first coil or the second coil.

Patent Document 1: JP2005158927 (A)

### BRIEF SUMMARY OF THE INVENTION

The present invention has been achieved under such circumstances. It is an object of the invention to provide a coil device allowing an easy adjustment of the coupling degree between a first coil and a second coil and having a small size.

To achieve the above object, a coil device according to the present invention comprises:
a first coil and a second coil;
bobbins combined with each other and provided with the first coil and the second coil; and
a core attached to the bobbins,

wherein
the core includes:
   a pair of outer leg portions;
   a middle leg portion located between the pair of outer leg portions; and
   a protrusion located between one of the outer leg portions and the middle leg portion, and
the second coil is disposed in a range different from that of the first coil so as to surround the middle leg portion and the protrusion.

In the coil device according to the present invention, the second coil is disposed in a range (an area) different from that of the first coil so as to surround the middle leg portion and the protrusion. Thus, the leakage magnetic flux between the first coil and the second coil can be adjusted based on the position, size, shape, etc. of the protrusion. This makes it possible to adjust the coupling degree between the first coil and the second coil and makes it easy to adjust the coupling degree between the first coil and the second coil. Also, since the coupling degree between the first coil and the second coil can be adjusted without adjusting the distance between the first coil and the second coil, the coil device can be downsized.

Also, the coil device according to the present invention includes bobbins combined with each other. Thus, for example, a wire can be wound around a single bobbin while the bobbins are separated, and the winding operation of the wire is easy.

The first coil may be disposed so as to surround the middle leg portion. In this case, since both of the first coil and the second coil are arranged so as to surround the middle leg portion, the coupling degree between the first coil and the second coil can be ensured favorably.

A transverse cross-sectional area of the protrusion may be smaller than that of the middle leg portion. In this case, leakage magnetic flux is appropriately generated between the first coil and the second coil, and it is thereby easy to adjust the coupling degree between the first coil and the second coil. Moreover, the core can be prevented from increasing its size, and the coil device can be downsized.

The bobbins may include: an annular first bobbin; and a non-annular second bobbin combined with the first bobbin, one end of the second bobbin in its extension direction may be attached to a first position of the first bobbin in its circumferential direction, and an other end of the second bobbin in its extension direction may be attached to a second position of the first bobbin in its circumferential direction. When the non-annular second bobbin is combined with the annular first bobbin, a compact bobbin assembly can be formed, and the coil device can be downsized. Also, a wire can be wound around a single bobbin in a state where the first bobbin and the second bobbin are separated, and a wire can be wound around the bobbins in a state where the first bobbin and the second bobbin are combined. Thus, the winding operation of the wire is easy.

The second bobbin may be curved in a C-shape along the circumferential direction of the first bobbin. In this case, a space (a gap) is likely to be formed between the first bobbin and the second bobbin, and the protrusion of the core can be disposed in the space.

The first coil may be provided on an outer circumferential surface of the first bobbin, and the second coil may include: a first section provided on an outer circumferential surface of the first coil; and a second section provided on an outer circumferential surface of the second bobbin. In this case, since the second bobbin is not disposed between the outer circumferential surface of the first coil and the first section of the second coil, the coil device can be downsized accordingly.

Each of a first wire constituting the first coil and a second wire constituting the second coil may be an insulated wire. In this case, the insulation between the outer peripheral surface of the first coil and the first section of the second coil is ensured, and the generation of short circuit defects therebetween can be prevented.

The middle leg portion may be disposed inside the first bobbin, the second bobbin may be combined with the first bobbin so as to form a space between the first bobbin and the second bobbin, and the protrusion may be disposed in the space. When the first coil is disposed so as to surround the main body portion and the second coil is disposed so as to surround the first bobbin and the second bobbin, the middle leg portion is surrounded by the first coil, and the middle leg portion and the protrusion are surrounded by the second coil. This generates a leakage magnetic flux between the first coil and the second coil and makes it possible to adjust the leakage magnetic flux between the first coil and the second coil based on the position, size, shape, etc. of the protrusion.

The protrusion may include: a first protrusion located between the middle leg portion and one of the outer leg portions; and a second protrusion located between the middle leg portion and the other of the outer leg portions, and the second coil may be disposed in a range different from that of the first coil so as to surround the middle leg portion, the first protrusion, and the second protrusion. In this case, the leakage magnetic flux between the first coil and the second coil can be adjusted over a large range based on the position, size, shape, etc. of each of the protrusions.

The bobbins may include: an annular first bobbin; a non-annular second bobbin combined with the first bobbin; and a non-annular third bobbin combined with the first bobbin at a position different from that of the second bobbin, the middle leg portion may be disposed inside the first bobbin, the second bobbin may be combined with the first bobbin so as to form a first space between the first bobbin and the second bobbin, the third bobbin may be combined with the first bobbin so as to form a second space between the first bobbin and the second bobbin, the first protrusion may be disposed in the first space, and the second protrusion may be disposed in the second space. In this case, when: the first coil is disposed so as to surround the first bobbin; and the second coil is disposed so as to surround the first bobbin, the second bobbin, and the third bobbin, the middle leg portion is surrounded by the first coil, and the middle leg portion and the protrusions are surrounded by the second coil. This generates a leakage magnetic flux between the first coil and the second coil and makes it possible to adjust the leakage magnetic flux between the first coil and the second coil over a large range based on the position, size, shape, etc. of each of the protrusions.

### BRIEF DESCRIPTION OF THE DRAWING(S)

FIG. 1 is a perspective view of a coil device according to First Embodiment of the present invention;

FIG. 2 is an exploded perspective view of the coil device shown in FIG. 1;

FIG. 3 is a perspective view of a core shown in FIG. 2;

FIG. 4 is a perspective view of a first bobbin and a second bobbin shown in FIG. 2;

FIG. 5 is a perspective view in which a first coil and a second coil are arranged in an assembly of the first bobbin and the second bobbin shown in FIG. 4;

FIG. 6 is a plane view in which a core is further disposed in the assembly of the first bobbin and the second bobbin shown in FIG. 5;

FIG. 7 is a transverse cross-sectional view in which a core is disposed in the assembly of the first bobbin and the second bobbin shown in FIG. 4;

FIG. 8 is a transverse cross-sectional view in which a first coil and a second coil are further arranged in the assembly of the first bobbin and the second bobbin shown in FIG. 7;

FIG. 9 is a perspective view of a coil device according to Second Embodiment of the present invention;

FIG. 10 is an exploded perspective view of the coil device shown in FIG. 9;

FIG. 11 is a perspective view in which a first coil and a second coil are arranged in an assembly of a first bobbin and a second bobbin shown in FIG. 10; and

FIG. 12 is a transverse cross-sectional view in which a core is further disposed in the assembly of the first bobbin and the second bobbin shown in FIG. 11.

### DETAILED DESCRIPTION OF THE INVENTION

Hereinafter, embodiments of the present invention are described with reference to the figures. Note that, the illustrated contents are merely shown schematically and exemplarily for understanding the present invention, and the appearance, size ratio, etc. may be different from the actual one. Also, the present invention is not limited to the following embodiments.

### First Embodiment

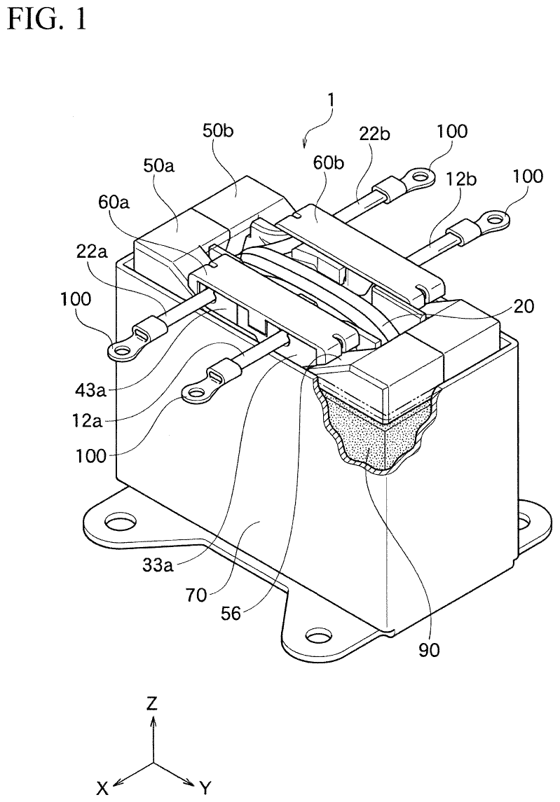

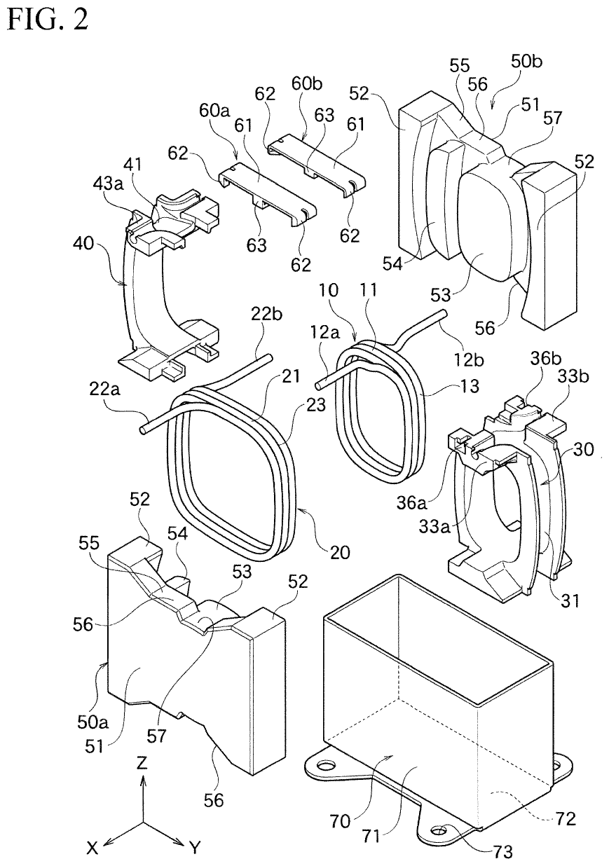

A coil device 1 according to First Embodiment of the present invention shown in FIG. 1 functions as, for example, a leakage transformer and is applied to in-vehicle chargers, electric power circuits for various electrical devices, etc. As shown in FIG. 2, the coil device 1 includes a first coil 10, a second coil 20, a first bobbin 30, a second bobbin 40, and cores 50a and 50b. The coil device 1 may further include caps 60a and 60b and a case 70. The coil device 1 is a coil device in which the axis of the first bobbin 30 or the axis of the first coil 10 (or the second coil 20) is disposed in parallel to a mounting board (not shown).

In FIG. 2, etc., the X-axis is an axis parallel to the axis of the first coil 10 or the second coil 20. Also, the X-axis is an axis parallel to the short-length direction of the core 50a or 50b when the core 50a or 50b is viewed in plane. The Y-axis is an axis parallel to the long-length direction of the core 50a or 50b when the core 50a or 50b is viewed in plane. The Z-axis is an axis perpendicular to the X-axis and the Y-axis. In the following description, for each of the X-axis, Y-axis, and Z-axis, the direction toward the center of the coil device 1 is referred to as “inside”, and the direction away from the center of the coil device 1 is referred to as “outside”.

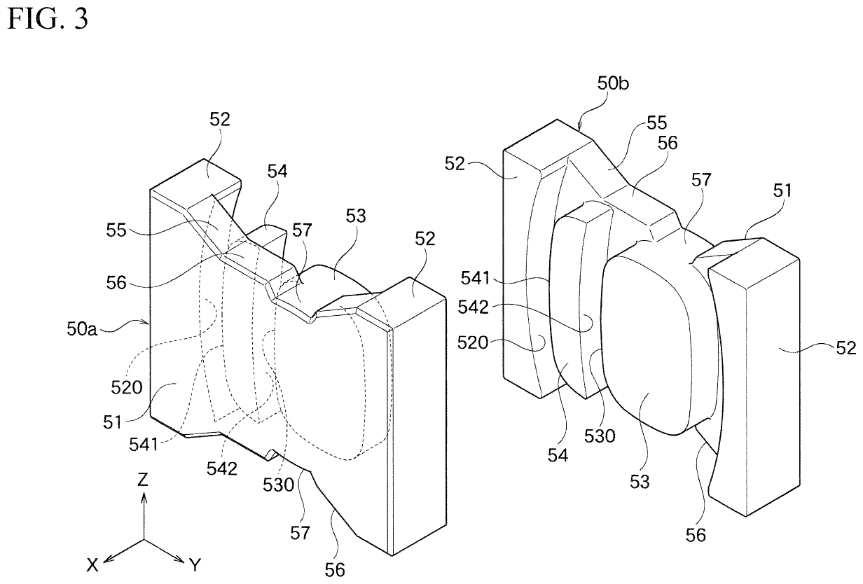

As shown in FIG. 3, the core 50a and the core 50b have minor-symmetrical shapes with respect to the X-axis. The cores 50a and 50b (excluding a protrusion 54, which is described below) are E-type cores and attached to an assembly of the first bobbin 30 and the second bobbin 40 (FIG. 2). The shapes of the cores 50a and 50b are not limited to those shown in FIG. 3. For example, the core 50a may be an assembly of a plurality of split cores (e.g., a plurality of U-shaped cores). The same applies to the core 50b. One of the cores 50a and 50b may be an E-type core, and the other may be an I-type core. The material of the cores 50a and 50b is, for example, a magnetic material, such as metal and ferrite.

Each of the cores 50a and 50b includes a pair of outer leg portions 52, a middle leg portion 53, and a protrusion 54. Each of the cores 50a and 50b may further include a base portion 51. The base portion 51 is a plate having a predetermined thickness in the X-axis direction. A concave portion 56 concaved in a V-shape toward the center of the base portion 51 in the Y-axis direction is formed on each of side surfaces 55 of the base portion 51 in the Z-axis direction. Each of the concave portions 56 is located between one outer leg portion 52 and the other outer leg portion 52 along the Y-axis. A bottom portion 57 of each of the concave portions 56 is continuous with the outer peripheral surface of the middle leg portion 53.

The pair of outer leg portions 52 protrudes along the X-axis from one surface of the base portion 51 in the X-axis direction. One outer leg portion 52 is formed at one end of the base portion 51 in the Y-axis direction, and the other outer leg portion 52 is formed at the other end of the base portion 51 in the Y-axis direction.

The middle leg portion 53 is located between the pair of outer leg portions 52. The middle leg portion 53 protrudes along the X-axis from one surface of the base portion 51 in the X-axis direction. The middle leg portion 53 is displaced from the center of the base portion 51 to one side (the positive side in the Y-axis direction) along the Y-axis. That is, the center of the middle leg portion 53 and the center of the base portion 51 do not coincide. However, the middle leg portion 53 may be located at the center of the base portion 51 in the Y-axis direction. The transverse cross-sectional shape of the middle leg portion 53 (the cross-sectional shape perpendicular to the axial direction of the middle leg portion 53) is an ellipse, but may be circular, polygonal, or the like.

The protrusion 54 is located between the pair of outer leg portions 52. Also, the protrusion 54 is located between one of the pair of outer leg portions 52 and the middle leg portion 53. The protrusion 54 is displaced from the center of the base portion 51 to the other side (the negative side in the Y-axis direction) along the Y-axis. That is, in the Y-axis direction, the protrusion 54 and the middle leg portion 53 are offset on opposite sides with respect to the center of the base portion 51. However, the protrusion 54 may be located at the center of the base portion 51 in the Y-axis direction. As with the middle leg portion 53, the protrusion 54 may be offset from the center of the base portion 51 to one side (the positive side in the Y-axis direction) along the Y-axis.

The protrusion length of the protrusion 54 along the X-axis is equal to the protrusion length of the middle leg portion 53 along the X-axis direction, but may be smaller or larger than the protrusion length of the middle leg portion 53 along the X-axis direction. Also, the protrusion length of the protrusion 54 along the X-axis is equal to the protrusion length of the outer leg portions 52 along the X-axis direction, but may be smaller or larger than the protrusion length of the outer leg portions 52 along the X-axis direction.

The transverse cross-sectional shape of the protrusion 54 (the cross-sectional shape perpendicular to the axial direction of the protrusion 54) is different from the transverse cross-sectional shape of the middle leg portion 53, but may be equal to the transverse cross-sectional shape of the middle leg portion 53. In the present embodiment, the transverse cross-sectional shape of the protrusion 54 is a curved shape in a C-shape (arc-shape or arch-shape). The protrusion 54 may be bent to form a V-shape. The transverse cross-sectional shape of the protrusion 54 is a tapered shape becoming tapered toward the end of the protrusion 54 in its extension direction. The protrusion 54 is formed so as to be elongated when viewed from the X-axis direction. That is, when viewed from the X-axis direction, the length (full length) of the protrusion 54 in the Z-axis direction is larger than the length (full length) of the protrusion 54 in the Y-axis direction. Note that, the transverse cross-sectional shape of the protrusion 54 is not limited to the shape shown in FIG. 3 and may be an ellipse, circle, semicircle, semiellipse, quadrilateral, other polygons, or other shapes.

The outer peripheral surface of the protrusion 54 includes a first surface 541 facing the outer leg portion 52 and a second surface 542 facing the middle leg portion 53. Both of the first surface 541 and the second surface 542 are curved in a C-shape (arc-shape or arch-shape). The radius of curvature of at least a part of the first surface 541 may be smaller than the radius of curvature of the second surface 542. The radius of curvature of the second surface 542 (and/or the first surface 541) may be equal to the radius of curvature of a first surface 530 (at least a part of the first surface 530) of the middle leg portion 53 facing the second surface 542. The radius of curvature of the first surface 541 (and/or the second surface 542) may be equal to the radius of curvature of a second surface 520 (at least a part of the second surface 520) of the outer leg portion 52 facing the first surface 541.

In the Y-axis direction, the first surface 541 is curved so as to protrude toward a side opposite to a side where the middle leg portion 53 is disposed. Likewise, in the Y-axis direction, the second surface 542 is curved so as to protrude toward a side opposite to the side where the middle leg portion 53 is disposed. Thus, in the Y-axis direction, the protrusion 54 is curved as a whole so as to protrude toward a side opposite to the side where the middle leg portion 53 is disposed.

The length (total length) of the protrusion 54 in the Z-axis direction is larger than the length (total length) of the middle leg portion 53 in the Z-axis direction, but may be equal to or smaller than the length (total length) of the middle leg portion 53 in the Z-axis direction. The length (total length) of the protrusion 54 in the Y-axis direction is smaller than the length (total length) of the middle leg portion 53 in the Y-axis direction, but may be equal to or larger than the length (total length) of the middle leg portion 53 in the Y-axis direction. The transverse cross-sectional area of the protrusion 54 is smaller than the transverse cross-sectional area of the middle leg portion 53, but may be equal to or larger than the transverse cross-sectional area of the middle leg portion 53.

As shown in FIG. 2, the first coil 10 includes a winding portion 11 and a pair of lead portions 12a and 12b led out from the winding portion 11. The winding portion 11 is formed by winding a first wire 13 in a coil shape. The second coil 20 includes a winding portion 21 and a pair of lead portions 22a and 22b led out from the winding portion 20. The winding portion 21 is formed by winding a second wire 23 in a coil shape. The first coil 10 and the second coil 20 are arranged in an assembly of the first bobbin 30 and the second bobbin 40 combined with each other. One of the first coil 10 and the second coil 20 is a primary coil, and the other is a secondary coil.

Each of the first wire 13 and the second wire 23 is made of a conductive wire, such as a round wire, a rectangular wire, a stranded wire, a litz wire, and a braided wire made of copper, etc., or an insulated wire made by coating the conductive wire with an insulating film. The diameter of each of the first wire 13 and the second wire 23 is, for example, 1.0 to 3.0 mm The diameters of the first wire 13 and the second wire 23 may be equal to or different from each other. For example, the diameter of one of the first wire 13 and the second wire 23 may be larger than the wire diameter of the other wire in order to flow a larger electric current.

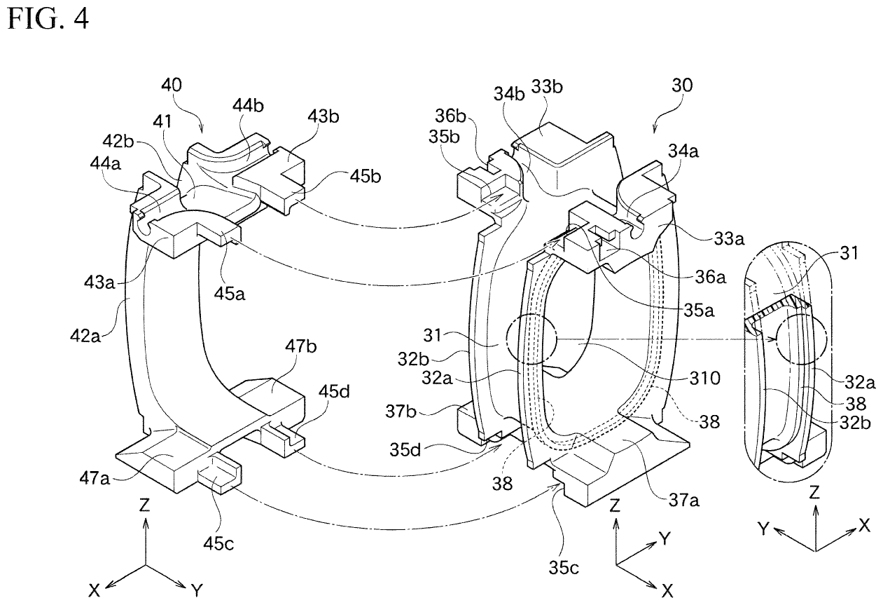

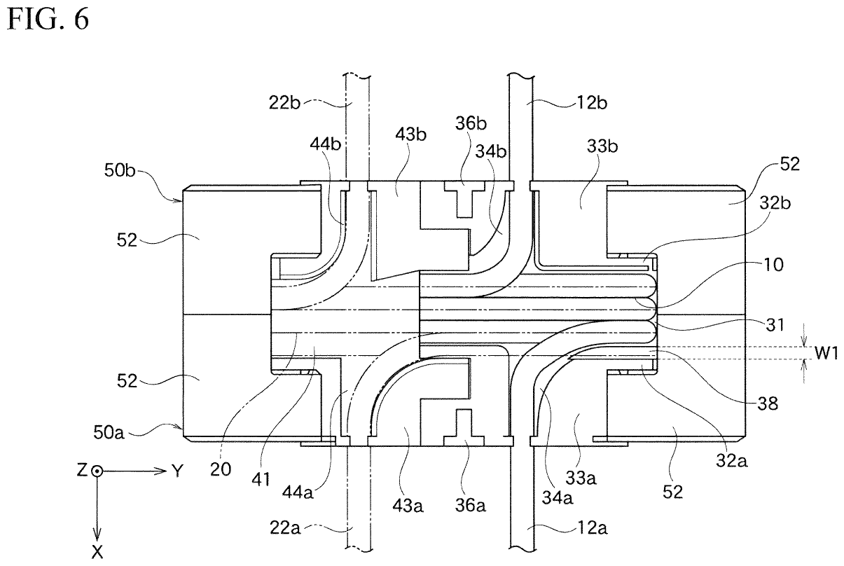

As shown in FIG. 4, the first bobbin 30 has an annular structure. The first bobbin 30 is made of plastic, such as PPS, PET, PBT, and LCP, or other insulating materials (preferably, heat-resistant materials). The first bobbin 30 includes a main body portion 31 provided with the first coil 10 (FIG. 2). The first bobbin 30 may further include flange portions 32a and 32b, projection portions 33a and 33b, groove portions 34a and 34b, engagement portions 35a to 35d, concave portions 36a and 36b, installation portions 37a and 37b, and a convex portion 38 (FIG. 6).

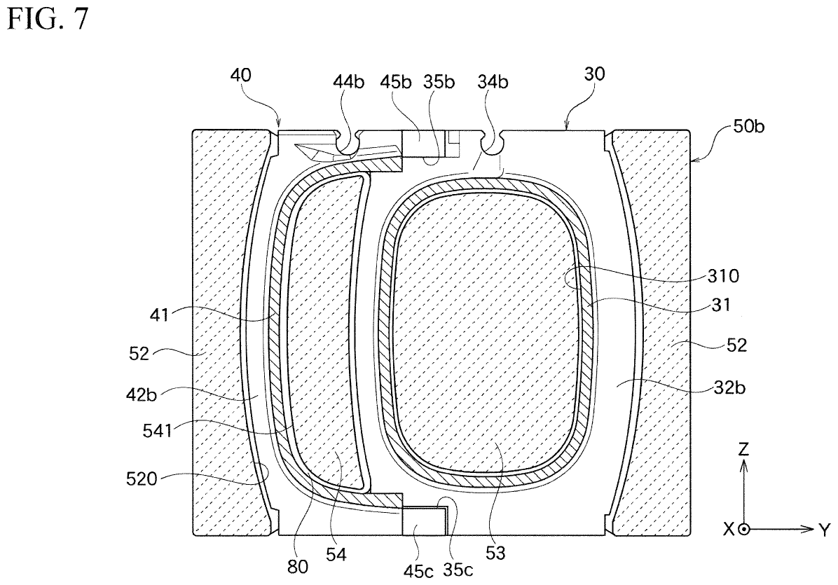

The main body portion 31 is formed in a cylindrical shape and includes a through hole 310. The middle leg portions 53 of the cores 50a and 50b (FIG. 3) are inserted into the through hole 310. The main body portion 31 is disposed along the outer peripheral surface of the middle leg portion 53. A part of the main body portion 31 is disposed in the space (the gap) between the protrusion 54 and the middle leg portion 53 (see FIG. 7). Also, a part of the main body portion 31 is disposed in the space between the middle leg portion 53 and the outer leg portion 52. The transverse cross-sectional shape of the main body portion 31 is a shape conforming to the transverse cross-sectional shape of the middle leg portion 53, namely, an elliptical shape (elliptical ring shape). However, the transverse cross-sectional shape of the main body portion 31 is not limited to the shape shown in FIG. 4 and may be circular, polygonal, or the like. The first coil 10 is provided on the outer peripheral surface of the main body portion 31 by, for example, winding the first wire 13 (FIG. 2) therearound.

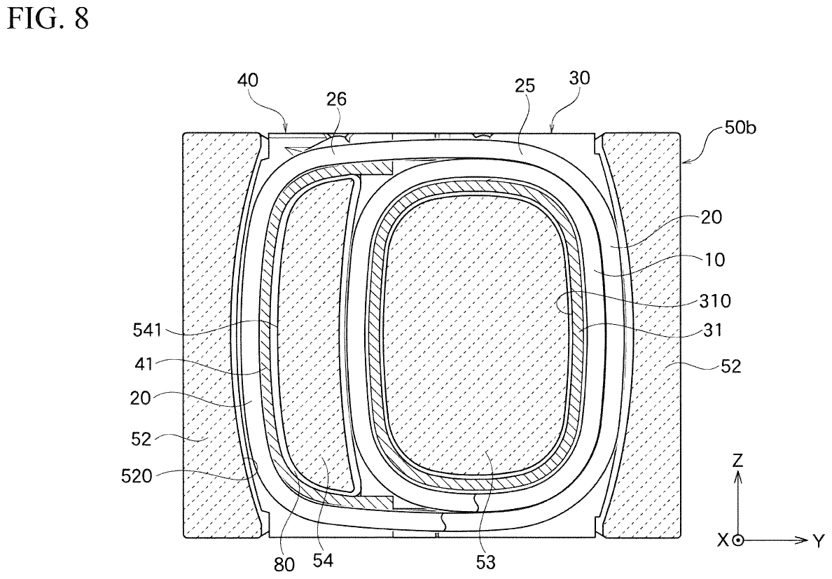

The flange portion 32a is formed at one end of the main body portion 31 in the X-axis direction, and the flange portion 32b is formed at the other end of the main body portion 31 in the X-axis direction. The flange portions 32a and 32b protrude from the outer peripheral surface of the main body portion 31 toward the outside in its radial direction. The flange portions 32a and 32b have a function of preventing the first coil 10 (FIG. 2) provided on the main body portion 31 from being displaced in the X-axis direction. Also, the flange portions 32a and 32b have a function of preventing the second coil 20 (FIG. 8) provided on the outer peripheral surface of the first coil 10 from being displaced in the X-axis direction. The protrusion length of the flange portion 32a toward the outside in the radial direction may be equal to or larger than the sum of the wire diameters of the first wire 13 and the second wire 23. The same applies to the flange portion 32b.

The projection portions 33a and 33b are formed at one end of the main body portion 31 in the Z-axis direction. The projection portion 33a projects from one side of the main body portion 31 toward the outside along the X-axis. The projection portion 33b projects from the other side of the main body portion 31 toward the outside along the X-axis. The projection portions 33a and 33b are formed at the top of the main body portion 31 having an elliptical shape. As shown in FIG. 1, the projection portion 33a is disposed in the concave portion 56 of the core 50a. Although detailed illustration is omitted, the projection portion 33b is disposed in the concave portion 56 of the core 50b. Each of the projection portions 33a and 33b may have a projection shape (convex shape) projecting toward the concave portion 56.

As shown in FIG. 4, the groove portion 34a is formed in the projection portion 33a, and the groove portion 34b is formed in the projection portion 33b. The groove portion 34a extends from one end to the other end of the projection portion 33a in the X-axis direction. The groove portion 34b extends from one end to the other end of the projection portion 33b in the X-axis direction. The groove portions 34a and 34b are communicated with the space between the flange portion 32a and the flange portion 32b. As shown in FIG. 6, the lead portion 12a of the first coil 10 can be inserted into the groove portion 34a, and the lead portion 12b of the first coil 10 can be inserted into the groove portion 34b. The lead portions 12a and 12b are led out to the outside of the main body portion 31 via the groove portions 34a and 34b, respectively.

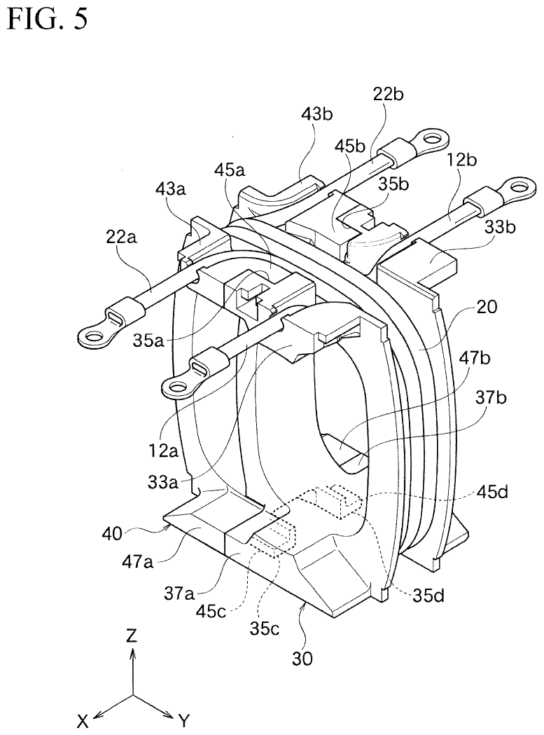

As shown in FIG. 4, the engagement portion 35a is formed in the projection portion 33a, and the engagement portion 35b is formed in the projection portion 33b. The engagement portions 35a and 35b are located on one side of the projection portions 33a and 33b in the Y-axis direction (the side close to the second bobbin 40), respectively. The engagement portions 35a and 35b are formed so as to cut out the inner ends of the projection portions 33a and 33b in the X-axis direction, respectively. The engagement portions 35a and 35b have a concave shape concaved in a hook-shape (L-shape) and are engaged with engagement portions 45a and 45b of the second bobbin 40, which are described below, respectively (see FIG. 5). Note that, the shapes of the engagement portions 35a and 35b is not limited to the shapes shown in FIG. 4 and may be, for example, hole shapes.

The concave portion 36a is formed in the projection portion 33a, and the concave portion 36b is formed in the projection portion 33b. The concave portions 36a and 36b are located on the outside of the projection portions 33a and 33b in the X-axis direction, respectively. The concave portions 36a and 36b are engaged with inner engagement portions 63 of the caps 60a and 60b (FIG. 2), which are described below, respectively.

The installation portions 37a and 37b are formed at the other end of the main body portion 31 in the Z-axis direction (the opposite side from the projection portion 33a). The installation portion 37a protrudes from one side of the main body portion 31 toward the outside along the X-axis. The installation portion 37b protrudes from the other side of the main body portion 31 toward the outside along the X-axis. The installation portions 37a and 37b are formed at the bottom portion of the main body portion 31 having an elliptical shape. Although detailed illustration is omitted, the installation portion 37a is disposed in the concave portion 56 (FIG. 2) of the core 50a, and the installation portion 37b is disposed in the concave portion 56 of the core 50b. The installation portions 37a and 37b may have a protrusion shape (convex shape) protruding toward the concave portion 56.

The engagement portion 35c is formed in the installation portion 37a, and the engagement portion 35d is formed in the installation portion 37b. The engagement portions 35c and 35d are located on one side of the installation portions 37a and 37b in the Y-axis direction (the side close to the second bobbin 40), respectively. The engagement portions 35c and 35d are formed so as to cut out the inner ends of the installation portions 37a and 37b in the X-axis direction, respectively. The engagement portions 35c and 35d have a concave shape concaved in a hook-shape (L-shape) and are engaged with engagement portions 45c and 45d of the second bobbin 40, which are described below, respectively (see FIG. 5). Note that, the shapes of the engagement portions 35c and 35d are not limited to the shapes shown in FIG. 4 and may be, for example, hole shapes.

As shown in FIG. 4 and FIG. 6, the convex portion 38 is formed on the outer peripheral surface of the main body portion 31 so as to be next to the flange portion 32a. The convex portion 38 protrudes from the outer circumferential surface of the main body portion 31 to the outside of the main body portion 31 in its radial direction and extends along the circumferential direction of the main body portion 31. The length W1 of the convex portion 38 in the X-axis direction is, for example, ⅓ or more and 1 or less of the wire diameter of the first wire 13. The convex portion 38 has a function of adjusting the position of the first coil 10 disposed on the outer peripheral surface of the main body portion 31. The first coil 10 is disposed between the convex portion 38 and the flange portion 32b so as to be displaced to the negative side in the X-axis direction by a distance corresponding to the length W1 of the convex portion 38 in the X-axis direction.

As shown in FIG. 4, the second bobbin 40 has a non-annular structure and is combined with the first bobbin 30 from one side in the Y-axis direction. For more detail, the second bobbin 40 is combined with the first bobbin 30 so as to be next to the longer side part (the side part in the Y-axis direction) of the main body portion 31 in the Y-axis direction. The second bobbin 40 is made of, for example, plastic, such as PPS, PET, PBT, and LCP, or other insulating materials (preferably, heat-resistant materials). The second bobbin 40 has a curved shape in a C-shape (arc-shape or arch-shape) along the circumferential direction of the main body portion 31. The second bobbin 40 may be bent in a V-shape. The second bobbin 40 includes a main body portion 41 provided with a part of the second coil 20 (FIG. 2). The second bobbin 40 may further include flange portions 42a and 42b, projection portions 43a and 43b, groove portions 44a and 44b, engagement portions 45a to 45d, and installation portions 47a and 47b.

The main body portion 41 is curved in a C-shape (arc-shape or arch-shape) and formed in a half-ring shape (semi-cylindrical shape). The radius of curvature of the main body portion 41 may be equal to or different from the radius of curvature of the first surface 541 (FIG. 3) of the protrusion 54. Also, the radius of curvature of the main body portion 41 may be equal to or different from the radius of curvature of the second surface 520 (FIG. 3) of the outer leg portion 52. As shown in FIG. 7, at least a part of the main body portion 41 is disposed in the space between the protrusion 54 and one of the outer leg portions 52. Also, the main body portion 41 is disposed along the first surface 541 of the protrusion 54. Also, the main body portion 41 is disposed along the second surface 520 of the outer leg portion 52. As shown in FIG. 8, a space for disposing the second coil 20 is formed between the outer circumferential surface of the main body portion 41 and the second surface 520 of the outer leg portion 52. When the second bobbin 40 is combined with the first bobbin 30, at least a part of the main body portion 41 (a part of the main body portion 41 facing the main body portion 31) is disposed along the main body portion 31.

As shown in FIG. 4, the flange portion 42a is formed at one end of the main body portion 41 in the X-axis direction, and the flange portion 42b is formed at the other end of the main body portion 41 in the X-axis direction. The flange portions 42a and 42b protrude from the outer peripheral surface of the main body portion 41 toward the outside in its radial direction. The flange portions 42a and 42b have a function of preventing the second coil 20 (FIG. 2) provided in the main body portion 41 from being displaced in the X-axis direction. The protrusion length of the flange portion 42a toward the outside in its radial direction may be equal to or larger than the wire diameter of the second wire 23. The same applies to the flange portion 42b.

The projection portions 43a and 43b are formed at one end of the main body portion 41 in the Z-axis direction. The projection portion 43a projects from one side of the main body portion 41 toward the outside along the X-axis. The projection portion 43b projects from the other side of the main body portion 41 toward the outside along the X-axis. The projection portions 43a and 43b are formed at the top of the main body portion 41 having an elliptical shape. As shown in FIG. 1, the projection portion 43a is disposed in the concave portion 56 of the core 50a. Although detailed illustration is omitted, the projection portion 43b is disposed in the concave portion 56 (FIG. 2) of the core 50b. The projection portions 43a and 43b may have a projection shape (convex shape) projecting toward the concave portion 56.

As shown in FIG. 4, the groove portion 44a is formed in the projection portion 43a, and the groove portion 44b is formed in the projection portion 43b. The groove portion 44a extends from one end to the other end of the projection portion 43a in the X-axis direction. The groove portion 44b extends from one end to the other end of the projection portion 43b in the X-axis direction. The groove portions 44a and 44b are communicated with the space between the flange portion 42a and the flange portion 42b. As shown in FIG. 6, the lead portion 22a of the second coil 20 can be inserted into the groove portion 44a, and the lead portion 22b of the second coil 20 can be inserted into the groove portion 44b. The lead portions 22a and 22b are led out to the outside of the main body portion 41 via the groove portions 44a and 44b, respectively.

As shown in FIG. 4, the engagement portion 45a is formed in the projection portion 43a, and the engagement portion 45b is formed in the projection portion 43b. The engagement portions 45a and 45b are located on the other side of the projection portions 43a and 43b in the Y-axis direction (the side close to the first bobbin 30), respectively. The engagement portions 45a and 45b protrude from the ends of the projection portions 43a and 43b to the inside along the Y-axis (the side close to the first bobbin 30). The engagement portions 45a and 45b have a concave shape concaved in a hook-shape (L-shape) and are engaged with the engagement portions 35a and 35b of the first bobbin 30, respectively (see FIG. 5).

The installation portions 47a and 47b are formed at the other end of the main body portion 41 in the Z-axis direction (the opposite side from the projection portion 43a). The installation portion 47a protrudes from one side of the main body portion 41 toward the outside along the X-axis. The installation portion 47b protrudes from the other side of the main body portion 41 toward the outside along the X-axis. The installation portions 47a and 47b are formed at the bottom of the main body portion 41 having an elliptical shape. Although detailed illustration is omitted, the installation portion 47a is disposed in the concave portion 56 (FIG. 2) of the core 50a, and the installation portion 47b is disposed in the concave portion 56 of the core 50b. The installation portions 47a and 47b may have a protrusion shape (convex shape) protruding toward the concave portion 56.

The engagement portion 45c is formed in the installation portion 47a, and the engagement portion 45d is formed in the installation portion 47b. The engagement portions 45c and 45d are located on the other side of the installation portions 47a and 47b in the Y-axis direction (the side close to the first bobbin 30), respectively. The engagement portions 45c and 45d protrude from the ends of the installation portions 47a and 47b toward the inside (the side close to the first bobbin 30) along the Y-axis. The engagement portions 45c and 45d have a concave shape concaved in a hook-shape (L-shape) and are engaged with the engagement portions 35c and 35d of the first bobbin 30, respectively (see FIG. 5).

As shown in FIG. 5, in the assembly of the first bobbin 30 and the second bobbin 40, one end of the second bobbin 40 in its extension direction is attached to a first position of the first bobbin 30 in its circumferential direction (the projection portions 33a and 33b located at the top of the main body portion 31 shown in FIG. 4). Also, the other end of the second bobbin 40 in its extension direction is attached to a second position of the first bobbin 30 in its circumferential direction (the installation portions 37a and 37b located at the bottom of the main body portion 31 shown in FIG. 4).

As shown in FIG. 7, the main body portion 41 is curved in a C-shape along the circumferential direction of the main body portion 31. Thus, in the assembly of the first bobbin 30 and the second bobbin 40, a space 80 is formed between the main body portions 31 and 41, and the protrusion 54 is disposed in the space 80. Also, the middle leg portion 53 is disposed inside the main body portion 31.

As shown in FIG. 8, the first coil 10 is disposed in the main body portion 31 so as to surround the middle leg portion 53. Also, the second coil 20 is disposed on the outside of the first coil 10 in its radial direction so as to surround the middle leg portion 53. In the present embodiment, since both of the first coil 10 and the second coil 20 are arranged so as to surround the middle leg portion 53, the coupling degree between the first coil 10 and the second coil 20 can be ensured favorably.

The first coil 10 passes through a space between the middle leg portion 53 and one outer leg portion 52 and a space between the middle leg portion 53 and the protrusion 54. Meanwhile, the second coil 20 passes through a space between the middle leg portion 53 and one of the outer leg portions 52 and a space between the protrusion 54 and the other outer leg portion 52. Accordingly, the second coil 20 is disposed in a range (region) different from that of the first coil 10 so as to collectively surround the middle leg portion 53 and the protrusion 54. Also, the second coil 20 is disposed in a range (region) larger than that of the first coil 10 so as to surround the middle leg portion 53, the protrusion 54, and the first coil 10.

The range (region) for disposing the second coil 20 is between one outer leg portion 52 and the other outer leg portions 52. Further, the range (region) for disposing the second coil 20 is outside the middle leg portion 53 and the protrusion 54. Thus, the range for disposing the second coil 20 includes the middle leg portion 53 and the protrusion 54. Meanwhile, the range (region) for disposing the first coil 10 is between one outer leg portion 52 (the outer leg portion 52 on the positive side in the Y-axis direction) and the protrusion 54. Thus, the range for disposing the first coil 10 includes the middle leg portion 53.

The second coil 20 includes a first section 25 provided on the outer peripheral surface of the first coil 10 and a second section 26 provided on the outer peripheral surface of the main body portion 41 of the second bobbin 40. The first section 25 is disposed (stacked) on a part of the outer circumferential surface of the first coil 10 (a region of the outer circumferential surface of the first coil 10 on the positive side in the Y-axis direction) along the circumferential direction of the first coil 10. At least a part of the first section 25 is disposed between the middle leg portion 53 and the outer leg portion 52. Neither the first bobbin 30 nor the second bobbin 40 is disposed between the first section 25 and the outer circumferential surface of the first coil 10, and the first section 25 is in direct contact with the outer circumferential surface of the first coil 10. Thus, the coil device 1 can be downsized by an amount of the wall thicknesses of these bobbins. Moreover, since each of the first wire 13 and the second wire 23 is made of an insulated wire, the insulation between the outer peripheral surface of the first coil 10 and the first section 25 of the second coil 20 is ensured, and the generation of short circuit defects therebetween can be prevented.

The second section 26 is disposed over the entire region of the main body portion 41 along the circumferential direction of the main body portion 41. The second section 26 may be disposed in a part of the main body portion 41 along the circumferential direction of the main body portion 41. At least a part of the second section 26 is disposed between the protrusion 54 and the outer leg portion 52. A part of the second coil 20 located between the first section 25 and the second section 26 may pass along the circumferential direction of the second coil 20 between the outer circumferential surface of the first coil 10 and the outer circumferential surface of the main body portion 41.

The outer circumferential surface of the main body portion 41 is disposed at a position where the outer circumferential surface of the first coil 10 is virtually extended along the circumferential direction of the first coil 10. Thus, the second coil 20 is curved at a predetermined curvature from the outer peripheral surface of the first coil 10 to the outer peripheral surface of the main body portion 41 at the top or bottom of the second coil 20.

As shown in FIG. 6, the lead portion 12a is led out from the main body portion 31 via the groove portion 34a and is further led out more outward than one end of the projection portion 33a along the X-axis. Also, the lead portion 12b is led out from the main body portion 31 via the groove portion 34b and is further led out more outward than the other end of the projection portion 33b along the X-axis. Also, the lead portion 22a is led out from the main body portion 41 via the groove portion 44a and is further led out more outward than one end of the projection portion 43a along the X-axis. Also, the lead portion 22b is led out from the main body portion 41 via the groove portion 44b and is further led out more outward than the other end of the projection portion 43b along the X-axis. As shown in FIG. 1, a terminal 100 may be attached to each of the tips of the lead portions 12a, 12b, 22a, and 22b.

The second coil 20 is displaced as a whole from the first coil 10 to one side in the X-axis direction (the side where the projection portion 33a is located). A part of the second coil 20 is disposed on the convex portion 38. However, the position of the second coil 20 is not limited to the position shown in FIG. 6.

As shown in FIG. 2, the case 70 includes a side portion 71, a bottom portion 72, and a boss portion 73. The case 70 is made of, for example, a metal with excellent cooling properties, such as aluminum. The case 70 is formed with an opening for accommodating the first bobbin 30, the second bobbin 40, and the like. A part of the coil device 1, such as the first bobbin 30, the second bobbin 40, the core 50a, and the core 50b, are exposed from the opening of the case 70 (see FIG. 1). A fastener, such as a screw, can be fixed to the boss portion 73. This makes it possible to attach the case 70 to a mounting board (not illustrated).

As shown in FIG. 1, a potting resin 90 can be filled into the case 70. The potting resin 90 is a heat dissipating resin and is made of silicone resin, urethane resin, epoxy resin, or the like. The potting resin 90 is filled to the vicinity of the opening of the case 70, for example, up to about 70 to 90% of the height of the side portion 71.

In the present embodiment, the heat of the first coil 10, the second coil 20, the first bobbin 30, the second bobbin 40, the core 50a, the core 50b, and the like is efficiently radiated to the outside via the case 70 and the potting resin 90, and it is possible to increase the cooling efficiency of the coil device 1.

As shown in FIG. 2, each of the caps 60a and 60b includes a covering portion 61, a pair of outer engagement portions 62, and an inner engagement portion 63. The covering portion 61 is made of a flat plate and has a rectangular shape in plane view. The pair of outer engagement portions 62 is formed at one end and the other end of the covering portion 61 in the Y-axis direction, respectively, and protrudes from one end of the covering portion 61 toward the inside along the Z-axis. The inner engagement portion 63 is located between the pair of outer engagement portions 62 and protrudes from one end of the covering portion 61 toward the inside along the Z-axis.

The inner engagement portion 63 of the cap 60a is engaged with the concave portion 36a of the first bobbin 30. One outer engagement portion 62 of the cap 60a is engaged with the end of the projection portion 33a of the first bobbin 30 in the Y-axis direction. The other outer engagement portion 62 of the cap 60a is engaged with the end of the projection portion 43a of the second bobbin 40 in the Y-axis direction. The covering portion 61 is attached to the ends of the projection portions 33a and 43a in the Z-axis direction so as to cover the projection portions 33a and 43a (see FIG. 1).

The inner engagement portion 63 of the cap 60b is engaged with the concave portion 36b of the first bobbin 30. One outer engagement portion 62 of the cap 60b is engaged with the end of the projection portion 33b of the first bobbin 30 in the Y-axis direction. The other outer engagement portion 62 of the cap 60b is engaged with the end of the projection portion 43b of the second bobbin 40 in the Y-axis direction. The covering portion 61 is attached to the ends of the projection portions 33b and 43b in the Z-axis direction so as to cover the projection portions 33b and 43b.

Next, a method of manufacturing a coil device 1 is described. First, each member shown in FIG. 2 is prepared. Next, a first wire 13 is wound around a main body portion 31 of a first bobbin 30 to form a winding portion 11 around the main body portion 31. At this time, as shown in FIG. 6, a lead portion 12a may be led out more outward than a projection portion 33a in the X-axis direction via a groove portion 34a. Also, a lead portion 12b may be led out more outward than a projection portion 33b in the X-axis direction via a groove portion 34b.

Next, as shown in FIG. 5, a second bobbin 40 is combined with the first bobbin 30 on which the first coil 10 is formed. The second bobbin 40 is combined with the first bobbin 30 by, for example, engaging engagement portions 45a to 45d of the second bobbin 40 with engagement portions 35a to 35d of the first bobbin 30 in the direction of the arrows in FIG. 4.

Next, as shown in FIG. 5, a second coil 20 is formed on an assembly of the first bobbin 30 and the second bobbin 40. For more detail, as shown in FIG. 8, a second wire 23 is wound on the outer circumferential surface of the first coil 10 and on a main body portion 41 so as to bridge a part of the outer circumferential surface of the first coil 10 and the outer circumferential surface of the main body portion 41 of the second bobbin 40. At this time, as shown in FIG. 6, a lead portion 22a may be led out more outward than a projection portion 43a in the X-axis direction via a groove portion 44a. Also, a lead portion 22b may be led out more outward than a projection portion 43b in the X-axis direction via a groove portion 44b.

Next, cores 50a and 50b shown in FIG. 2 are attached to an assembly of the first bobbin 30 and the second bobbin 40 provided with the first coil 10 and the second coil 20. For more detail, as shown in FIG. 8, middle leg portions 53 of the cores 50a and 50b are inserted into a through hole 310 of the first bobbin 30. Also, protrusions 54 of the cores 50a and 50b are inserted into a space 80 between the main body portion 31 and the main body portion 41. Also, a pair of outer leg portions 52 is disposed on both sides of the assembly of the first bobbin 30 and the second bobbin 40 in the Y-axis direction. If necessary, the core 50a and the core 50b may be bonded with an adhesive or the like.

Next, as shown in FIG. 1, a cap 60a is attached to the projection portions 33a and 43a so as to straddle them. Also, a cap 60b is attached to the projection portions 33b and 43b (FIG. 4) so as to straddle them. Note that, the timing of attaching the caps 60a and 60b may be changed as appropriate.

Next, the assembly of the first bobbin 30 and the second bobbin 40 provided with the cores 50a and 50b is accommodated into a case 70 shown in FIG. 2. Next, as shown in FIG. 1, a potting resin 90 is filled into the case 70. Accordingly, the coil device 1 can be manufactured.

As described above, in the present embodiment, as shown in FIG. 8, the second coil 20 is disposed in a range different from that of the first coil 10 so as to surround the middle leg portion 53 and the protrusion 54. Thus, the leakage magnetic flux between the first coil 10 and the second coil 20 can be adjusted based on the position, size, shape, etc. of the protrusion 54. This makes it possible to adjust the coupling degree between the first coil 10 and the second coil 20 and makes it easy to adjust the coupling degree between the first coil 10 and the second coil 20. Also, since the coupling degree between the first coil 10 and the second coil 20 can be adjusted without adjusting the distance between the first coil 10 and the second coil 20 in the axial direction, the coil device 1 can be downsized. Moreover, the coupling degree between the first coil 10 and the second coil 20 can be adjusted without adjusting the distance between the first coil 10 and the second coil 20 in the radial direction along the entire circumference, and in this respect as well, the coil device 1 can be downsized. Moreover, in the coil device 1 of the present embodiment, it is possible to prevent deterioration of AC resistance characteristics and reduce copper loss.

Also, the coil device 1 includes the first bobbin 30 and the second bobbin 40 combined with each other. Thus, for example, the first wire 13 can be wound around a single bobbin (the first bobbin 30) while the first bobbin 30 and the second bobbin 40 are separated, and the winding operation of the first wire 13 is easy.

Also, the transverse cross-sectional area of the protrusion 54 is smaller than that of the middle leg portion 53. Thus, leakage magnetic flux is appropriately generated between the first coil 10 and the second coil 20, and it is thereby easy to adjust the coupling degree between the first coil 10 and the second coil 20. Moreover, the cores 50a and 50b can be prevented from increasing their sizes, and the coil device 1 can be downsized.

Also, as shown in FIG. 4 and FIG. 5, the coil device 1 includes the annular first bobbin 30 and the non-annular second bobbin 40 combined with the first bobbin 30, and one end of the second bobbin 40 in its extension direction is attached to the top of the first bobbin 30 in its circumferential direction, and the other end of the second bobbin 40 in its extension direction is attached to the bottom of the first bobbin 30 in its circumferential direction. When the non-annular second bobbin 40 is combined with the annular first bobbin 30 from the side in the Y-axis direction, a compact bobbin assembly can be formed, and the coil device 1 can be downsized, compared to the case where an annular second bobbin is combined with an annular first bobbin. Also, the first wire 13 can be wound around a single bobbin (the first bobbin 30) in a state where the first bobbin 30 and the second bobbin 40 are separated, and the second wire 23 can be wound around an assembly of bobbins (the first bobbin 30 and the second bobbin 40) in a state where the first bobbin 30 and the second bobbin 40 are combined. Thus, the winding operation of the first wire 13 and the second wire 23 is easy.

Also, the middle leg portion 53 is disposed inside the main body portion 31, and the protrusion 54 is disposed in the space 80 between the main body portion 31 and the main body portion 41. When: the first coil 10 is provided so as to surround the main body portion 31; and the second coil 20 is provided so as to collectively surround the main body portion 31 and the main body portion 41, the middle leg portion 53 is surrounded by the first coil 10, and the middle leg portion 53 and the protrusion 54 are surrounded by the second coil 20. Thus, a leakage magnetic flux is generated between the first coil 10 and the second coil 20, and it is possible to adjust the leakage magnetic flux between the first coil 10 and the second coil 20 based on the position, size, shape, etc. of the protrusion 54.

### Second Embodiment

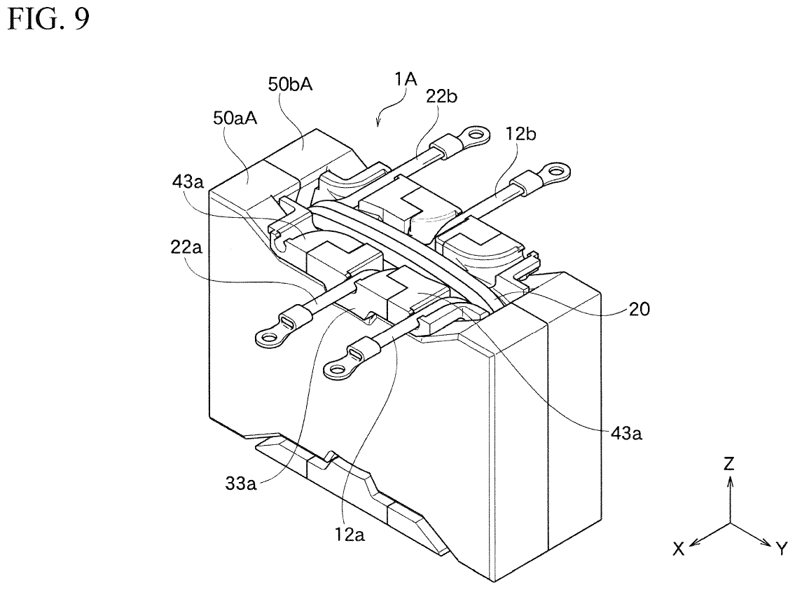

Except for the following matters, a coil device 1A according to Second Embodiment shown in FIG. 9 has configurations similar to those of the coil device 1 according to First Embodiment. The same reference numerals are given to overlapping members with the coil device 1 of First Embodiment and are not described in detail.

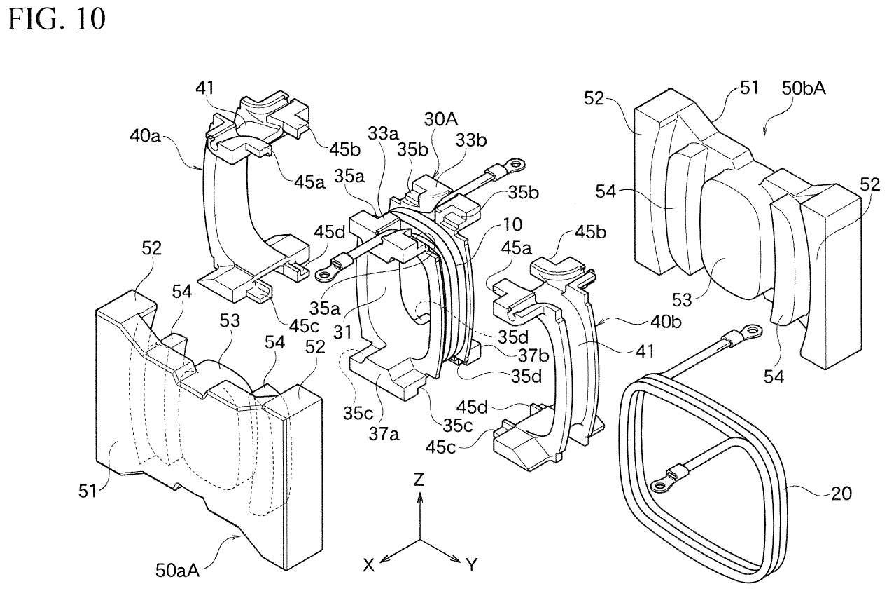

As shown in FIG. 10, the coil device 1A includes a first bobbin 30A, two second bobbins 40a and 40b, and cores 50aA and 50bA. Each of the cores 50aA and 50bA includes two protrusions 54. One protrusion 54 is located between the middle leg 53 and one outer leg portion 52. The other protrusion 54 is located between the middle leg portion 53 and the other outer leg portion 52.

The first bobbin 30A includes two engagement portions 35a, two engagement portions 35b, two engagement portions 35c, and two engagement portions 35d. The two engagement portions 35a are formed in the projection portion 33a so as to be located on opposite sides from each other along the Y-axis. The two engagement portions 35b are formed in the projection portion 33b so as to be located on opposite sides from each other along the Y-axis. The two engagement portions 35c are formed in the installation portion 37a so as to be located on opposite sides from each other along the Y-axis. The two engagement portions 35d are formed in the installation portion 37b so as to be located on opposite sides from each other along the Y-axis.

The second bobbins 40a and 40b have the same configuration as the second bobbin 40 of First Embodiment. The second bobbin 40a is combined with the first bobbin 30A from one side in the Y-axis direction. Also, the second bobbin 40a is combined with the first bobbin 30A so as to be next to the longer side part (side part) of the main body portion 31 in the Y-axis direction.

The second bobbin 40b is combined with the first bobbin 30A at a position different from that of the second bobbin 40a. For more detail, the second bobbin 40b is combined with the first bobbin 30A from the other side in the Y-axis direction. Also, the second bobbin 40b is combined with the first bobbin 30A so as to be next to the longer side part (side part) of the main body portion 31 in the Y-axis direction.

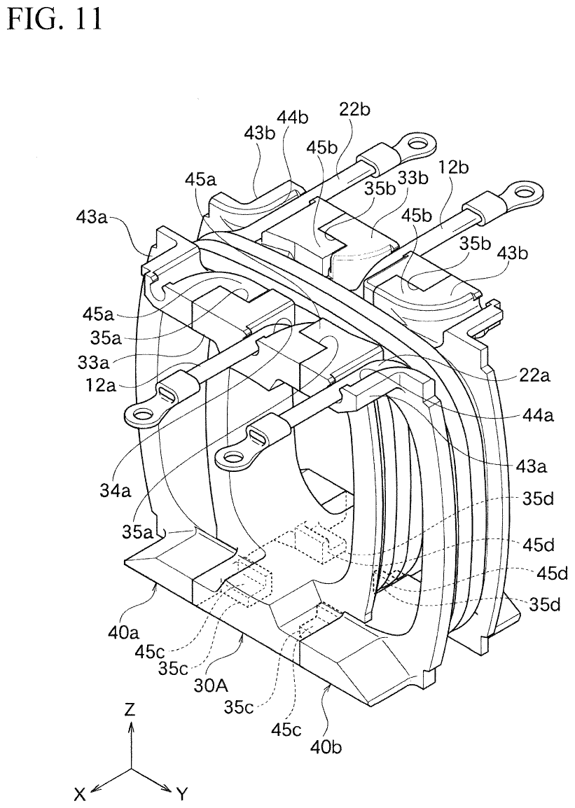

As shown in FIG. 11, the engagement portion 45a of the second bobbin 40a is engaged with the engagement portion 35a facing the engagement portion 45a in the Y-axis direction. The engagement portion 45b of the second bobbin 40a is engaged with the engagement portion 35b of the first bobbin 30A facing the engagement portion 45b in the Y-axis direction. The engagement portion 45c of the second bobbin 40a is engaged with the engagement portion 35c of the first bobbin 30A facing the engagement portion 45c in the Y-axis direction. The engagement portion 45d of the second bobbin 40a is engaged with the engagement portion 35d of the first bobbin 30A facing the engagement portion 45d in the Y-axis direction.

Also, the engagement portion 45a of the second bobbin 40b is engaged with the engagement portion 35a facing the engagement portion 45a in the Y-axis direction. The engagement portion 45b of the second bobbin 40b is engaged with the engagement portion 35b of the first bobbin 30A facing the engagement portion 45b in the Y-axis direction. The engagement portion 45c of the second bobbin 40b is engaged with the engagement portion 35c of the first bobbin 30A facing the engagement portion 45c in the Y-axis direction. The engagement portion 45d of the second bobbin 40b is engaged with the engagement portion 35d of the first bobbin 30A facing the engagement portion 45d in the Y-axis direction.

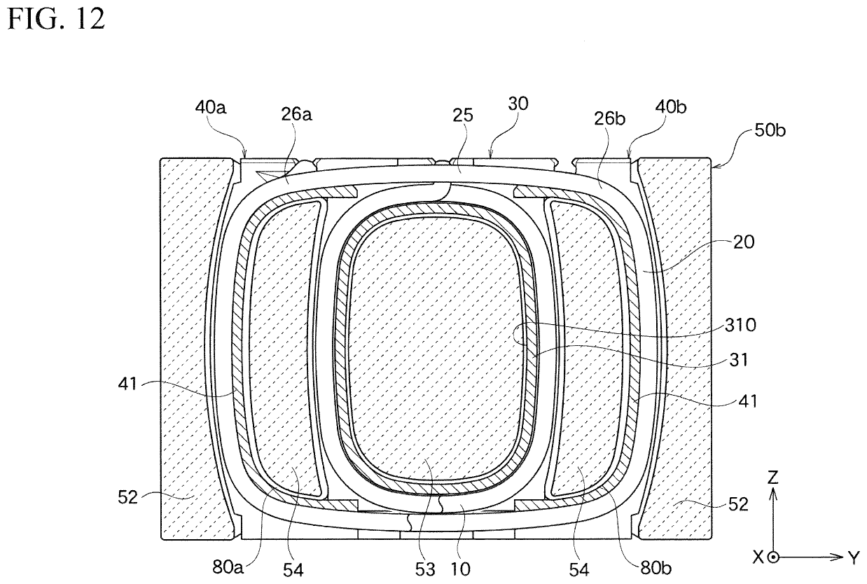

As shown in FIG. 12, the middle leg portion 53 is disposed inside the main body portion 31. Also, one protrusion 54 is disposed in a space 80a between the main body portion 31 and the main body portion 41 of the second bobbin 40a, and the other protrusion 54 is disposed in a space 80b between the main body portion 31 and the main body portion 41 of the second bobbin 40b.

The first coil 10 is disposed on the outer peripheral surface of the main body portion 31 so as to surround the middle leg portion 53. Meanwhile, the second coil 20 is disposed in a range different from that of the first coil 10 (a range larger than that of the first coil 10) so as to surround the middle leg portion 53 and the pair of protrusions 54. The second coil 20 is disposed on the outside of the first coil 10 in its radial direction so as to surround the first coil 10 in addition to the middle leg portion 53 and the pair of protrusions 54.

The second coil 20 includes the first section 25 disposed on the outer circumferential surface of the first coil 10, a second section 26a disposed on the outer circumferential surface of the main body portion 41 of the second bobbin 40a, and a second section 26b disposed on the outer circumferential surface of the main body portion 41 of the second bobbin 40b. At least a part of the second section 26a is disposed between one protrusion 54 and one outer leg portion 52, and at least a part of the second portion 26b is disposed between the other protrusion 54 and the other outer leg portion 52. The first section 25 is mainly disposed at the top and bottom of the first coil 10 in the Z-axis direction. A part of the second coil 20 located between the first section 25 and the second section 26a may pass along the circumferential direction of the second coil 20 between the outer circumferential surface of the first coil 10 and the outer circumferential surface of the main body portion 41 of the second bobbin 40a. Also, a part of the second coil 20 located between the first section 25 and the second section 26b may pass along the circumferential direction of the second coil 20 between the outer circumferential surface of the first coil 10 and the outer circumferential surface of the main body portion 41 of the second bobbin 40b.

Also in the present embodiment, effects similar to those in First Embodiment can be obtained. Moreover, in the present embodiment, the second coil 20 is disposed in a range different from that of the first coil 10 so as to surround the middle leg portion 53 and the pair of protrusions 54. Thus, the leakage magnetic flux between the first coil 10 and the second coil 20 can be adjusted over a large range based on the position, size, shape, etc. of each of the protrusions 54.

Also, the coil device 1A includes the annular first bobbin 30A, the non-annular second bobbin 40a combined with the first bobbin 30A, and the non-annular second bobbin 40b combined with the first bobbin 30A at a position different from that of the second bobbin 40a. Then, the middle leg portion 53 is disposed inside the main body portion 31, one protrusion 54 is disposed in the space 80a between the main body portion 31 and the main body portion 41 of the second bobbin 40a, and the other protrusion 54 is disposed in the space 80b between the main body portion 31 and the main body portion 41 of the second bobbin 40b. Thus, when: the first coil 10 is disposed so as to surround the main body portion 31; and the second coil 20 is disposed so as to collectively surround the first bobbin 30A and the second bobbins 40a and 40b, the middle leg portion 53 is surrounded by the first coil 10, and the middle leg portion 53 and the protrusions 54 are surrounded by the second coil 20. This generates a leakage magnetic flux between the first coil 10 and the second coil 20 and makes it possible to adjust the leakage magnetic flux between the first coil 10 and the second coil 20 over a large range based on the position, size, shape, etc. of each of the protrusions 54.

Note that, the present invention is not limited to the above-mentioned embodiments and may be variously modified within the scope of the present invention. For example, in each of the above-mentioned embodiments, an application example of the present invention to a transformer is described, but the present invention may be applied to a coil device other than transformers.

In First Embodiment mentioned above, as shown in FIG. 3, the protrusion 54 is provided on each of the cores 50a and 50b, but the protrusion 54 may be provided on only one of the cores 50a and 50b. In Second Embodiment, the protrusions 54 may be provided only on one of the cores 50aA and 50bA shown in FIG. 10.

In First Embodiment mentioned above, the number of protrusions 54 on the core 50a or 50b shown in FIG. 3 may be two or more. In this case, two or more protrusions 54 may be arranged next to each other at predetermined intervals along the Y-axis. Also, the number of second bobbins 40 shown in FIG. 2 may be two or more. In this case, two or more second bobbins 40 may be arranged next to each other at predetermined intervals along the Y-axis.

As shown in FIG. 1 and FIG. 2, the coil device 1 of First Embodiment is a coil device in which the axes of the first coil 10 and the second coil 20 are arranged in parallel to a mounting board (not shown). However, the coil device 1 may be a coil device in which the axes of the first coil 10 and the second coil 20 are arranged perpendicularly to a mounting board (not shown). The same applies to the coil device 1A of Second Embodiment mentioned above.

### Description of the Reference Numerical

1, 1A . . . coil device
10 . . . first coil
11 . . . winding portion
12a, 12b . . . lead portion
13 . . . first wire
20 . . . second coil
21 . . . winding portion
22a, 22b . . . lead portion
23 . . . second wire
30, 30A . . . first bobbin
31 . . . main body portion
32a, 32b . . . flange portion
33a, 33b . . . projection portion
34a, 34b . . . groove portion
35a, 35b, 35c, 35d . . . engagement portion
36a, 36b . . . concave portion
37a, 37b . . . installation portion
38 . . . convex portion
40 . . . second bobbin
41 . . . main body portion
42a, 42b . . . flange portion
43a, 43b . . . projection portion
44a, 44b . . . groove portion
45a, 45b, 45c, 45d . . . engagement portion
47a, 47b . . . installation portion
50a, 50b . . . core
51 . . . base portion
52 . . . outer leg portion
53 . . . middle leg portion
54 . . . protrusion
55 . . . side surface
56 . . . concave portion
57 . . . bottom portion
60a, 60b . . . cap
61 . . . covering portion
62 . . . outer engagement portion
63 . . . inner engagement portion
70 . . . case
71 . . . side portion
72 . . . bottom portion
73 . . . boss portion
80, 80a, 80b . . . space
90 . . . potting resin

What is claimed is:

1. A coil device comprising:
a first coil and a second coil;
bobbins combined with each other and provided with the first coil and the second coil; and
a core attached to the bobbins,
wherein
the core includes:
a pair of outer leg portions;
a middle leg portion located between the pair of outer leg portions; and
a protrusion located between one of the outer leg portions and the middle leg portion, and
the second coil is disposed in a range different from that of the first coil so as to surround the middle leg portion and the protrusion.

2. The coil device according to claim 1, wherein the first coil is disposed so as to surround the middle leg portion.

3. The coil device according to claim 1, wherein a transverse cross-sectional area of the protrusion is smaller than that of the middle leg portion.

4. The coil device according to claim 1, wherein
the bobbins includes:
an annular first bobbin; and
a non-annular second bobbin combined with the first bobbin,
one end of the second bobbin in its extension direction is attached to a first position of the first bobbin in its circumferential direction, and
an other end of the second bobbin in its extension direction is attached to a second position of the first bobbin in its circumferential direction.

5. The coil device according to claim 4, wherein the second bobbin is curved in a C-shape along the circumferential direction of the first bobbin.

6. The coil device according to claim 4, wherein
the first coil is provided on an outer circumferential surface of the first bobbin, and
the second coil includes:
a first section located on an outer circumferential surface of the first coil; and
a second section located on an outer circumferential surface of the second bobbin.

7. The coil device according to claim 6, wherein each of a first wire constituting the first coil and a second wire constituting the second coil is an insulated wire.

8. The coil device according to claim 4, wherein
the middle leg portion is disposed inside the first bobbin,
the second bobbin is combined with the first bobbin so as to form a space between the first bobbin and the second bobbin, and
the protrusion is disposed in the space.

9. The coil device according to claim 1, wherein
the protrusion includes:
a first protrusion located between the middle leg portion and one of the outer leg portions; and
a second protrusion located between the middle leg portion and the other of the outer leg portions, and
the second coil is disposed in a range different from that of the first coil so as to surround the middle leg portion, the first protrusion, and the second protrusion.

10. The coil device according to claim 9, wherein
the bobbins includes:
an annular first bobbin;
a non-annular second bobbin combined with the first bobbin; and
a non-annular third bobbin combined with the first bobbin at a position different from that of the second bobbin,
the middle leg portion is disposed inside the first bobbin,
the second bobbin is combined with the first bobbin so as to form a first space between the first bobbin and the second bobbin,
the third bobbin is combined with the first bobbin so as to form a second space between the first bobbin and the second bobbin,
the first protrusion is disposed in the first space, and
the second protrusion is disposed in the second space.
